(19) United States
(12) Patent Application Publication
(10) Pub. No.: US 2015/0143301 A1
(43) Pub. Date: May 21, 2015

(54) Evaluating Three-Dimensional Geographical Environments Using A Divided Bounding Area

(71) Applicant: Google Inc., Mountain View, CA (US)

(72) Inventors: Tilman Reinhardt, Woodside, CA (US); Bradley Bossard, Portland, OR (US)

(73) Assignee: Google Inc., Mountain View, CA (US)

(21) Appl. No.: 13/739,613

(22) Filed: Jan. 11, 2013

Related U.S. Application Data
(60) Provisional application No. 61/656,566, filed on Jun. 7, 2012.

(51) Int. Cl. G06F 3/0481

(52) U.S. Cl. CPC G06F 3/04815
USPC 715/848

(57) ABSTRACT

Embodiments relate to evaluating structures located in a geographic area that is divided into divided bounding areas using a three-dimensional environment representing the structures. In an embodiment, a computer-implemented method includes a method for dividing a three-dimensional environment depicting the structures into the divided bounding areas where each divided bounding area encompasses a portion of structures. In the method, an evaluation web page for each divided bounding area is retrieved from a structure evaluation server where each evaluation web page provides an evaluation status for each divided bounding area. At least one structure encompassed by a selected divided bounding area is evaluated based on a visual representation of the structure. An updated evaluation web page for the selected divided bounding area is provided to the structure evaluation server where the updated evaluation web page provides an updated evaluation status for the selected divided bounding area.

### FIELD

Embodiments relate to evaluating buildings represented by three-dimensional data.

### BACKGROUND

Three-dimensional data may be derived from a variety of sources including stereo imaging, computer-aided design software, laser range data, aerial imagery data or light detection and ranging (LIDAR). From this three-dimensional model data, automated processes are capable of three-dimensional model data that represents geographical structures that include natural and man-made structures, such as buildings, communication towers, trees, and the like. In additional to automated processes, manual processes are available to generate three-dimensional model data representing the structures. For examples, a user may generate the three-dimensional model data using an image-based modeling tool or a computer-aided design tool.

However, neither the automated or manual processes may consistently produce models that represent the geographic structures accurately. For automatically generated models, the inaccuracies may result from both inaccuracies of the source data and precision of the automated algorithms. For manually generated models, the inaccuracies may be due to human error. As result of these inaccuracies, some models may be produced that appear to be distorted representations of the geographic structures and other models may be produced from noisy source data that do not represent any geographic structure at all.

As a result, a human quality control filtering process may be required to sift out the accurate three-dimensional models from the inaccurate three-dimensional models. The quantity of buildings to be evaluated is often extensive so that the buildings to be evaluated are divided amongst several evaluators. However, evaluators who are not periodically updated on an evaluation status of the buildings may repeatedly evaluate buildings that have already been evaluated by other evaluators hindering the efficiency of the evaluation process.

Therefore, methods and systems to provide a three-dimensional representation of the three-dimensional models of the buildings where the evaluation status for the buildings to be evaluated is provided to each evaluator is desired.

### BRIEF SUMMARY

Embodiments relate to using divided bounding areas to coordinate the efforts of a plurality of building evaluators. In an embodiment, a computer implemented method evaluates geographical data that represents a plurality of structures located in a geographic area that is divided into a plurality of divided bounding areas using a three-dimensional environment representing the plurality of structures. The method includes accessing a three-dimensional environment depicting the plurality of structures in the geographic area. The three-dimensional environment is divided into the plurality of divided bounding areas. Each divided bounding area encompasses a portion of structures from the plurality of structures. An evaluation user interface for the plurality of divided bounding areas is provided from a structure evaluation server. The evaluation user interface provides an evaluation status for each divided bounding area. A user selection, from the provided evaluation user interface, of a divided bounding area from the plurality of divided bounding areas is received. Also, a user evaluation of at least one structure from the portion of structures encompassed by the selected divided bounding area is received. The user evaluation is based on a visual representation of the at least one structure depicted within the three-dimensional environment. An updated evaluation user interface for the selected divided bounding area to the structure evaluation server is provided. The updated evaluation web page providing an updated evaluation status for the selected divided bounding area.

System and computer program product embodiments are also disclosed.

Further embodiments, features, and advantages of the invention, as well as the structure and operation of the various embodiments of the invention are described in detail below with reference to accompanying drawings.

### BRIEF DESCRIPTION OF THE FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a diagram illustrating a user interface for enabling an evaluator to evaluate buildings from a three-dimensional perspective, according to an embodiment.

FIG. 2 shows a diagram showing a user interface that provides the evaluator with an evaluation status of each building in divided bounding areas, according to an embodiment.

FIG. 3 is a diagram showing a system for evaluating buildings using divided bounding areas, according to an embodiment.

FIG. 4 is a flowchart showing a method for evaluating geographical data using divided bounding areas, according to an embodiment.

The drawing in which an element first appears is typically indicated by the leftmost digit or digits in the corresponding reference number. In the drawings, like reference numbers may indicate identical or functionally similar elements.

### DETAILED DESCRIPTION OF EMBODIMENTS

In embodiments, three-dimensional model data may be further divided into bounding areas. Each bounding area may provide an evaluation status of the buildings encompassed by each bounding area to evaluators that may be evaluating the three-dimensional data of the buildings. In this way, embodiments enable coordination between quality control evaluators.

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### Evaluation of Three-Dimensional Data of Buildings

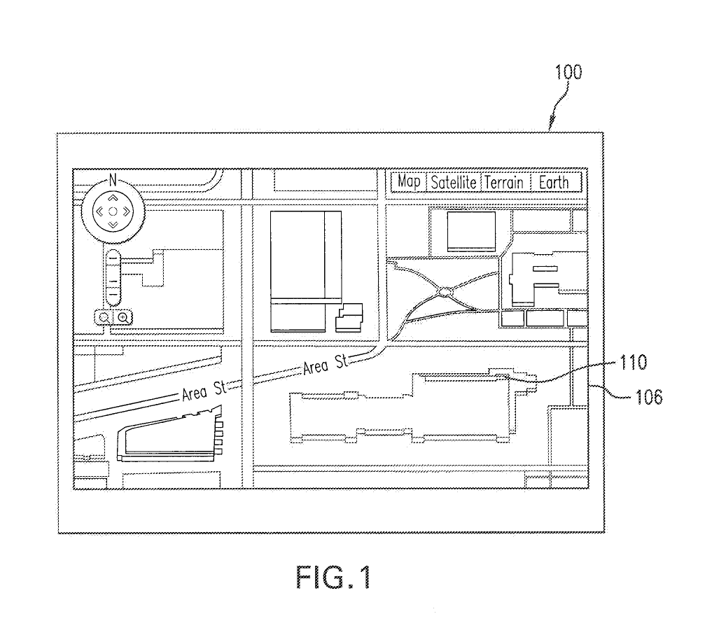

FIG. 1 is a diagram illustrating a user interface 100 enabling the evaluator to evaluate buildings from a three-dimensional perspective based on the three-dimensional data that represents the buildings. User interface 100 shows a three-dimensional model 106 depicting a three-dimensional perspective of building 110 based on the three-dimensional data representing building 110. For exemplary purposes, this document refers to evaluating models of buildings. However, it should be understood that models of other structures may also be evaluated, includes other natural and man-made structures, such as buildings, communication towers, trees, and the like, that may be distorted in images such as oblique images that may be stitched together. Further the three-dimensional perspective of three-dimensional model 106 as shown by user interface 100 may be changed to provide any three-dimensional perspective of three-dimensional model 106 and is not limited to a single three-dimensional perspective.

An evaluator may, for example, be tasked with evaluating building 110. Building 110 may be presented by images (e.g., satellite or aerial images or street-level panoramic images) that capture building 110. To evaluate properly building 110, the evaluator may require that building 110 be presented to the evaluator in a three-dimensional fashion within the context of an actual setting of building 110. The evaluator may be required to examine building 110 from several angles and viewpoints to determine properly whether building 110 is distorted. The evaluator may also be required to examine building 110 within an actual setting of building 110 which includes other buildings, streets, trees, and the like that may be located around building 110.

For example, static snapshots of building 110 may limit the evaluator to the angles and viewpoints of building 110 depicted in the static snapshots and prohibit the evaluator from examining the remaining angles and viewpoints of building 110. Angles and viewpoints of building 110 not depicted in the static snapshots may provide distortions of building 110 that may be missed by the evaluator relying on the static snapshots of building 110. Further, static snapshots of building 110 may also limit the evaluator to evaluate building 110 within the context presented by the static snapshots of building 110. Buildings, streets, trees, and the like that may be located around building 110 but not depicted by the static snapshots may hide distortions of building 110 that may only be identified by the evaluator when building 110 is depicted within the context of those missing buildings, streets, trees, and the like.

In embodiments, three-dimensional model data of building 110 may be used to represent building 110 in a three-dimensional fashion. Three-dimensional model data may be derived from a variety of sources including stereo imaging, computer-aided design software, laser range data, aerial imagery data or light detection and ranging (LIDAR). Three-dimensional model data of building 110 may be presented to the evaluator within the context of a larger three-dimensional environment 106. Three-dimensional environment 106 may provide a map of the Earth by the superimposition of images obtained from satellite imagery, aerial imagery, or street level panoramic imagery. Three-dimensional environment 106 may enable the evaluator to zoom in and examine building 110 from all angles and viewpoints to properly determine whether building 110 is accurate. Three-dimensional model 106 may also enable the evaluator to zoom out and examine building 110 within the context of the other buildings, streets, trees, and the like that may be located around building 110 to identify properly distortions that may only be identified within the context of those physical structures.

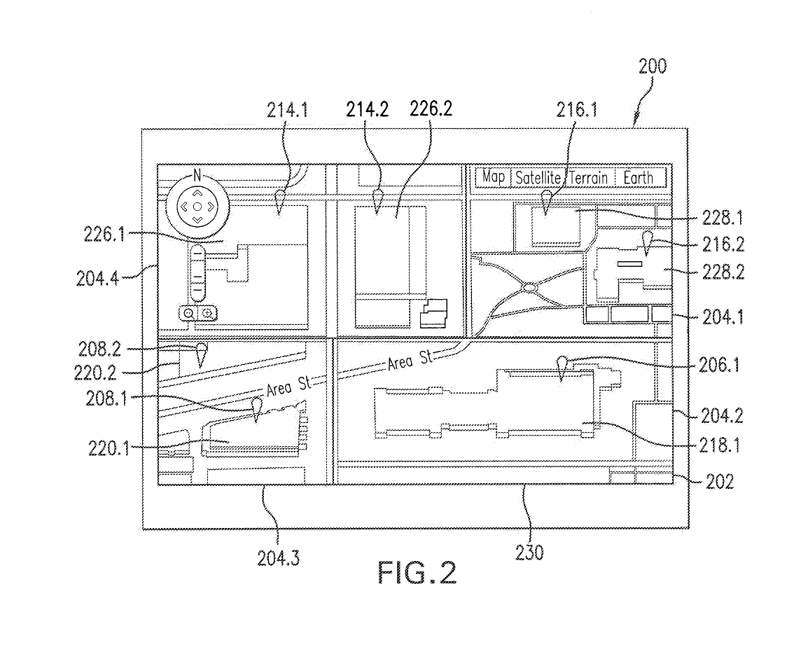

An evaluator may, for example, be tasked with evaluating several buildings similar to building 110. In a further example, several evaluators may be tasked with evaluating a large quantity of buildings similar to building 110. With a large quantity of buildings similar to building 110 to be evaluated by several evaluators, coordination between the evaluators regarding the evaluation of each building may be quite difficult. For example, a first evaluator may evaluate several hundred buildings. However, without an evaluation status provided to the other evaluators, a second evaluator may evaluate a portion of the several hundred buildings previously evaluated by the first evaluator and in turn hindering the efficiency and the overall completion of the evaluation process. Applications of providing an evaluation status for each building evaluated is described with respect to FIG. 2.

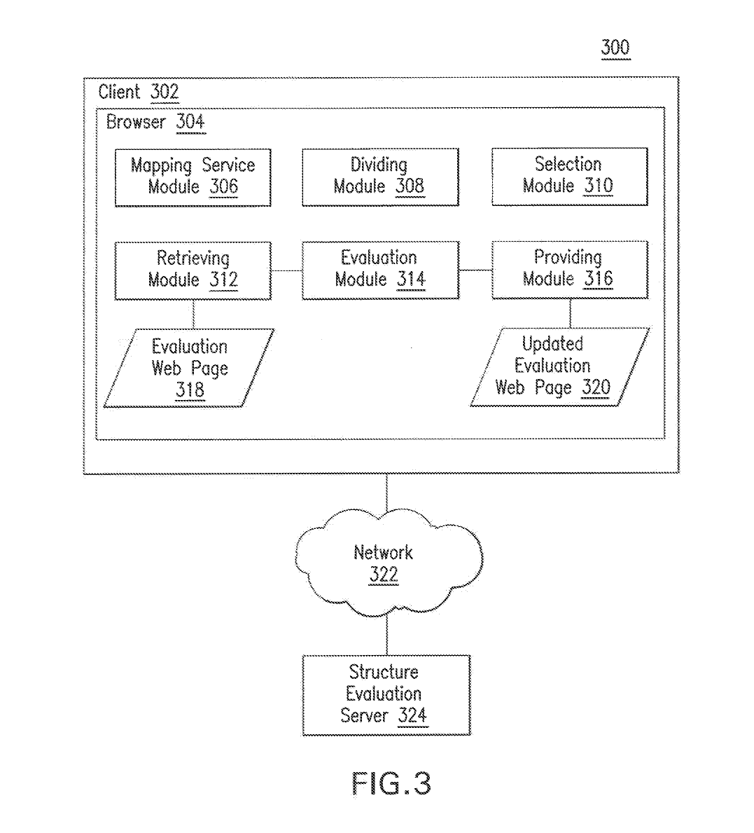

FIG. 2 shows a diagram showing a user interface 200 that provides the evaluator with an evaluation status of each building depicted. As described below with respect to FIG. 3, user interface 200, may in an embodiment, be a web based user interface. In the embodiment, a server may serve to a client data, such as Hypertext markup language (HTML) data, Javascript, or animation (e.g. FLASH) data, specifying user interface 200. Using that data, the client may render and display user interface 200 to a user.

User interface 200 shows a three-dimensional model 202 depicting a three-dimensional perspective of buildings that includes building 218.1 with indicator 206.1, building 220.1 with indicator 208.1, building 220.2 with indicator 208.2, building 226.1 with indicator 214.1, building 226.2 with indicator 214.2, building 228.1 with indicator 216.1, and building 228.2 with indicator 216.2. Three-dimensional model 202 is encompassed by encompassing bounding area 230. Encompassing bounding area 230 is divided into divided bounding area 204.1, divided bounding area 204.2, divided bounding area 204.3 and divided bounding area 204.4. Several evaluators may, for example, be tasked with evaluating hundreds of thousands of buildings. Each evaluator tasked with evaluating the hundreds of thousands of buildings may each perform the evaluation via a user interface independent to the evaluator. For example, a first evaluator may perform the evaluation via a first user interface, a second evaluator may perform the evaluation via a second user interface and so on. In an embodiment, each user interface used by each evaluator may be comparable to user interface 200 discussed in more detail below.

An evaluation of hundreds of thousands of buildings at a single time so that all the buildings are available to each evaluator at one time may be difficult. In an embodiment, the quantity of buildings to be evaluated by the several evaluators may be streamlined so that only a portion of the overall quantity of buildings, such as buildings 218.1 through 228.2 to provide an example, appear to each evaluator at one time by three-dimensional model 202 via user interface 200. In such an embodiment, an encompassing bounding area 230 may be created that encompasses a portion of the overall quantity of buildings to be evaluated such that three-dimensional model 202 via user interface 200 limits the quantity of buildings available to each evaluator.

For example, the overall quantity of buildings to be evaluated by the several evaluators may include a quantity of 100,000 buildings covering a large geographic area included in several cities. However, rather than three-dimensional model 202 depicting all 100,000 buildings, encompassing bounding area 230 may be created to capture a smaller portion of the quantity of 100,000 buildings. Encompassing bounding area 230 may capture buildings 218.1 through 228.2 so that three-dimensional model 202 may limit the depiction of buildings to buildings 218.1 through 228.2 rather than the complete quantity of 100,000 buildings. As a result, the evaluation of buildings 218.1 through 228.2 encompassed by encompassing bounding area 230 may be much simpler to manage as compared to evaluating the complete quantity of the 100,000 buildings.

In an embodiment, encompassing bounding area 230 may be defined by the evaluator. In such an embodiment, the evaluator defines encompassing bounding area 230 on three-dimensional model 202 such that encompassing bounding area 230 includes a portion of the buildings depicted by three-dimensional model 202 in which the evaluator desires to evaluate. As would be appreciated by one having skilled in the relevant art given the description herein, encompassing bounding area 230 may be defined to represent any type of enclosed boundary area that may include but is not limited to a square, a rectangle, a polygon, a circle, and/or any other enclosed boundary that can be used to a similar effect and without changing the applicability of this invention.

Encompassing bounding area 230 limits the quantity of buildings depicted by three-dimensional model 202 to the several evaluators. However, an evaluation of the smaller quantity of buildings limited by encompassing bounding area 230 so that all of the smaller quantity of buildings are available to each evaluator at one time may still be difficult, and may still be too daunting of a task for several evaluators to evaluate via independent user interfaces efficiently. In an embodiment, the quantity of buildings to be evaluated by the several evaluators may be further streamlined so that only a portion of the smaller quantity of buildings, such as buildings, such as buildings 220.1 and 220.2 to provide an example, appear to each evaluator at one time by three-dimensional model 202 via user interface 200.

In such an embodiment, the encompassing bounding area 230 may be further divided into dividing bounding areas 204.1 through 204.4. Rather than have each of the several evaluators coordinate the evaluation of buildings 218.1 through 228.2, each of buildings 218.1 through 228.2 may be apportioned to dividing bounding areas 204.1 through 204.4. Each of the several evaluators may coordinate the evaluation of buildings 218.1 through 228.2 by assigning dividing bounding areas 204.1 through 204.4 to each evaluator rather than evaluating each building 218.1 through 228.2 on an individual basis. The interference between evaluators in evaluating each building 218.1 through 228.2 may be decreased. In doing so, each dividing bounding area 204.1 through 204.4 may resemble a work unit. Once each building encompassed by one dividing bounding area 204.1 through 204.4 has been evaluated, the evaluator may move onto the next dividing bounding area 204.1 through 204.4 and evaluate each building encompassed in the next dividing bounding area 204.1 through 204.4. Such an apportionment may further streamline the evaluation process to improve the overall efficiency of the evaluation process. In other embodiments, more than two tiers of bounding areas may be available.

Rather than have the several evaluators coordinate the evaluation of each building 218.1 through 228.2 on an individual basis, the several evaluators may coordinate the evaluation of each building 218.1 through 228.2 based on divided bounding areas 204.1 through 204.4. For example, building 218.1 is included in divided bounding area 204.2, buildings 220.1 and 220.2 are included in divided bounding area 204.3, buildings 226.1 and 226.2 are included in divided bounding area 204.4, buildings 228.1 and 228.2 are included in divided bounding area 204.1.

In an embodiment, each of divided bounding areas 204.1 through 204.4 may divide encompassing bounding area 230 into rectangular regions that may be displayed by three-dimensional model 202 as a series of tiles. As would be appreciated by one having skilled in the relevant art given the description herein, divided bounding areas 204.1 through 204.4 may be defined to represent any type of enclosed boundary area that may include but is not limited to a square, a rectangle, a polygon, a circle, and/or any other enclosed boundary that can be used to a similar effect and without changing the applicability of this invention.

Once divided bounding areas 204.1 through 204.4 have been determined, each evaluator may select a divided bounding area from divided bounding areas 204.1 through 204.4 to operate in where each divided bounding area selected by each evaluator may be different. Each evaluator enter into in the selected divided bounding area via independent user interfaces and evaluate the buildings encompassed in each divided bounding area 204.1 through 204.4 simultaneously. For example, the first evaluator may enter into divided bounding area 204.1 via user interface 200. Divided bounding area 204.1 encompasses buildings 228.1 and 228.2. The first evaluator may evaluate buildings 228.1 and 228.2 to determine whether buildings 228.1 and 228.2 may be distorted. For example, the first evaluator may examine building 228.1 from all angles and viewpoints provided by three-dimensional model 202 to determine whether building 228.1 may be distorted. After making a decision on the distortion status of building 228.1, the first evaluator may move onto building 228.2 to determine whether building 228.2 may be distorted. The first evaluator may examine building 228.2 from all angles and viewpoints provided by three-dimensional model 202 to determine whether building 228.2 may be distorted. After examining both buildings 228.1 and 228.2, the overall evaluation the buildings included in divided bounding area 204.1 is completed.

The first evaluator may also execute an overall judgment on all of the buildings included in divided bounding area 204.1. For example, rather than examining each angle and viewpoint of buildings 228.1 and 228.2, the first evaluator may be able to easily observe that both building 228.1 and 228.2 are distorted without examining each building in an extensive fashion individually. The first evaluator may execute an overall judgment on dividing bound area 204.1 as a whole rather than individually on buildings 228.1 and 228.2.

As noted above, redundancy in evaluation of buildings 218.1 through 228.2 may occur amongst the several evaluators tasked with executing the evaluation from independent user interfaces. For example, the first evaluator may evaluate buildings 228.1 and 228.2 via a first user interface but then the second evaluator may also evaluate buildings 228.1 and 228.2 from a second user interface not realizing that buildings 228.1 and 228.2 had already been evaluated by the first evaluator via the first user interface. Such redundancy may hinder the overall efficiency of evaluating buildings 218.1 through 228.2. Thus, an evaluation status for each building 220.1 through 228.2 may be required to avoid redundant evaluations for each building 220.1 through 228.2.

In an embodiment, each building 218.1 through 228.2 may be assigned geographic coordinates. For example, each building 218.1 through 228.2 may include geographic coordinates based on the latitude and longitude location of each building 218.1 through 228.2. The geographic coordinates for buildings 218.1 through 228.2 may be part of the metadata for each building 218.1 through 228.2. Each building 218.1 through 228.2 may be linked to a structure evaluation server via the geographic coordinates present in the metadata for each building 218.1 through 228.2. As each building 218.1 through 228.2 may be evaluated, the change in evaluation status of each building 218.1 through 228.2 may be updated and stored by the structure evaluation server based on the geographic coordinates of each building 218.1 through 228.2.

In an embodiment, the evaluation status for each building 218.1 through 228.2 as updated and stored by the structure evaluation server may be provided to the several evaluators with indicators 206.1 through 216.2 via the independent user interfaces for each evaluator. Each indicator 206.1 through 216.2 may be paired with a corresponding building 218.1 through 228.2. For example, indicator 206.1 is paired with building 218.1, indicator 208.1 is paired with building 220.1, indicator 208.2 is paired with building 220.2, indicator 214.1 is paired with building 226.1, indicator 214.2 is paired with building 226.2, indicator 216.1 is paired with building 228.1, and indicator 216.2 is paired with building 228.2

As each evaluator evaluates building 218.1 through 228.2, the change in evaluation status of each building 218.1 through 228.2 is updated and stored by the structure evaluation server via the geographic coordinates of each building 218.1 through 228.2. The structure evaluation server then updates indicators 206.1 through 216.2 to reflect the change in evaluation status of each building 218.1 through 228.2. Each user interface that may be connected to the structure evaluation sever may receive an updated evaluation status of each building 218.1 through 228.2 via the updated indicators 206.1 through 216.2. In doing so, a change in evaluation status to buildings 218.1 through 228.2 performed by a first evaluator via a first user interface may be provided to a second evaluator that is using a second user interface based on the updated indicators 206.1 through 216.2 provided to the second user interface by the structure evaluation server.

For example, indicator 206.1 initially reflects a “not yet evaluated” evaluation status for building 218.1. The first evaluator evaluates building 218.1 via a first user interface and determines that building 218.1 is not distorted. Based on the geographic coordinates for building 218.1, the structure evaluation server updates and stores the change in evaluation status from “not yet evaluated” to “building not distorted.” Structure evaluation server then updates indicator 206.1 to reflect the “building not distorted” evaluation status for building 218.1. In doing so, every user interface connected to the structure evaluation server may receive the updated indicator 206.1 to reflect the “building not distorted” evaluation status for building 218.1.

In an embodiment, the evaluation status for each building 218.1 through 228.2 provided by each indicator 206.1 through 216.2 may be done by a color of each indicator 206.1 through 216.2. For example, indicators 206.1 through 216.2 may be red when buildings 218.1 through 228.2 have an evaluation status of “building inaccurate.” Indicators 206.1 through 216.2 may be green when buildings 218.1 through 228.2 have an evaluation status of “building accurate.” Indicators 206.1 through 216.2 may be blue when buildings 218.1 through 228.2 have an evaluation status of “not yet evaluated.”

In an embodiment, the evaluator may click on each indicator 206.1 through 216.2. When the evaluator clicks on each indicator 206.1 through 216.2, a web page may be retrieved from the structure evaluation server based on the geographic coordinates of each building 218.1 through 228.2 paired with each indicator 206.1 through 216.2. The web page may present to the evaluator a set of evaluation options for the building to be evaluated such as, “building distorted,” “building not distorted,” and “not yet evaluated.” The evaluator may then change the evaluation status via the web page. The structure evaluation sever may then update and store the evaluation status and then update each indicator 206.1 through 216.2 accordingly based on the evaluation status change made by the evaluator via the web page. In doing so, every user interface connected to the structure evaluation server may receive the updated indicator 206.1 through 216.2 accordingly based on the evaluation status change made by the evaluator via the web page.

As noted above, rather than have the several evaluators coordinate the evaluation of each building 218.1 through 228.2 on an individual basis via independent user interfaces, the several evaluators may coordinate the evaluation of each building 218.1 through 228.2 based on divided bounding areas 204.1 through 204.4. As with the evaluation of buildings 218.1 through 228.2 on an individual basis, redundancy in evaluation of divided bounding areas 204.1 through 204.4 may also occur amongst the several evaluators tasked with executing the evaluation. An evaluation status for each divided bounding area 204.1 through 204.4 may provide an evaluation summary for the buildings included in each divided bounding area 204.1 through 204.4 so that the evaluation process may be further streamlined to improve the overall efficiency of the evaluation process.

In an embodiment, each divided bounding area 204.1 through 204.4 may be assigned geographic coordinates. For example, each divided bounding area 204.1 through 204.4 may include geographic coordinates based on the latitude and longitude location of each divided bounding area 204.1 through 204.4. The geographic coordinates for divided bounding areas 204.1 through 204.4 may be part of the metadata for each divided bounding area 204.1 through 204.4. Each divided bounding area 204.1 through 204.4 may be linked to a structure evaluation server via the geographic coordinates present in the metadata for each divided bounding area 204.1 through 204.4. As each divided bounding area 204.1 through 204.4 may be evaluated, the change in evaluation status of each divided bounding area 204.1 through 204.4 may be updated and stored by the structure evaluation server based on the geographic coordinates of each divided bounding area 204.1 through 204.4.

As each evaluator evaluates divided bounding area 204.1 through 204.4, the change in evaluation status of each divided bounding area 204.1 through 204.4 is updated and stored by the structure evaluation server via the geographic coordinates of each divided bounding area 204.1 through 204.4. The structure evaluation server then updates an overlay for each divided bounding area 204.1 through 204.4 to reflect the change in evaluation status of each divided bounding area 204.1 through 204.4. Each user interface that may be connected to the structure evaluation server may receive an updated evaluation status of each divided bounding area 204.1 through 204.4 via the updated overlays. In doing so, a change in evaluation status to divided bounding area 204.1 through 204.4 performed by a first evaluator via a first user interface may be provided to a second evaluator that is using a second user interface based on the updated overlays provided to the second user interface by the structure evaluation server.

For example, the overlay for divided bounding area 204.4 initially reflects a “not yet evaluated” evaluation status for buildings 226.1 and 226.2 encompassed by divided bounding area 204.4. The first evaluator evaluates both buildings 226.1 and 226.2 and determines that both buildings 226.1 and 226.2 are not distorted. Based on the geographic coordinates for divided bounding area 204.4, the structure evaluation server updates and stores the change in evaluation status from “not yet evaluated” to “evaluated.” Structure evaluation server then updates the overlay for divided bounding area 204.4 to reflect the “evaluated” status for divided bounding area 204.4. In doing so, every user interface connected to the structure evaluation server may receive the updated overlay to reflect the “not yet evaluated” evaluation status for divided bounding area 204.4.

In another example, the overlay for divided bounding area 204.4 initially reflects a “not yet evaluated” evaluation status for buildings 226.1 and 226.2 encompassed by divided bounding area 204.4. The first evaluator evaluates building 226.1 but not building 226.2 and determines that building 226.1 is not distorted. Based on the geographic coordinates for divided bounding area 204.4, the structure evaluation server updates and stores the change in evaluation status from “not yet evaluated” to “partially evaluated” to represent that the evaluation of buildings encompassed by divided bounding area 204.4 has begun but not yet completed. Structure evaluation server then updates the overlay for divided bounding area 204.4 to reflect the “partially evaluated” status for divided bounding area 204.4. In doing so, every user interface connected to the structure evaluation server may receive the updated overlay to reflect the “partially evaluated” evaluation status for divided bounding area 204.4.

In an embodiment, the evaluation status for each divided bounding area 204.1 through 204.4 provided by each overlay for each divided bounding area 204.1 through 204.4 may be done by a color of each overlay. For example, the overlay for divided bounding area 204.4 may be red when neither buildings 226.1 and 226.2 have been evaluated so that divided bounding area 204.4 has an evaluation status of “not evaluated.” The overlay for divided bounding area 204.4 may be green when both buildings 226.1 and 226.2 have been evaluated so that divided bounding area 204.4 has an evaluation status of “evaluated.” The overlay for divided bounding area 204.4 may be blue when building 226.1 has been evaluated but building 226.2 has not been evaluated so that divided bounding area 204.4 has an evaluation status of “partially evaluated.”

In an embodiment, the evaluator opens a three-dimensional markup language file for each divided bounding area 204.1 through 204.4 which may be provided by the structure evaluation server when evaluating divided bounding area 204.1 through 204.4. The three-dimensional markup language may be an extensible markup language (XML) for expressing geographic annotation and visualization within Internet-based, two-dimensional maps and three-dimensional models, such as three-dimensional model 202. Each three-dimensional markup language file includes indicators 206.1 through 216.2 for each building 218.1 through 228.2 encompassed by divided bounding area 204.1 through 204.4 selected by the evaluator. Each three-dimensional markup language file also includes each overlay for each divided bounding area 204.1 through 204.4. As noted above, each building 218.1 through 228.2 may be paired with each indicator 206.1 through 216.2. Indicators 206.1 through 216.2 present the evaluation status of each building 218.1 through 228.2 to the evaluator. Also, each overlay for each divided bounding area 204.1 through 204.4 presents the evaluation status of each divided bounding area 204.1 through 204.4.

As the first evaluator selects each indicator 206.1 through 216.2 for each building 218.1 through 228.2 encompassed by the selected divided bounding area 204.1 through 204.4 via the first user interface, the web page for each selected indicator 206.1 through 216.2 is retrieved from the structure evaluation server. As noted above, the first evaluator changes the evaluation status for each building 218.1 through 228.2 via the web page for each indicator 206.1 through 216.2. As the first evaluator changes the evaluation status via the web page, the structure evaluation server updates the three-dimensional markup language file for the selected divided bounding area 204.1 through 204.4 to reflect the evaluation status change. The next instance in which the selected divided bounding area 204.1 through 204.4 may be selected by the second evaluator via the second user interface, the three-dimensional markup language file for the selected divided bounding area 204.1 through 204.4 may reflect the evaluation status change as provided by the structure evaluation server. The evaluation status change as provided by the structure evaluation server may include the updated indicator 206.1 through 216.2 encompassed by the selected divided bounding area 204.1 through 204.4 and also the updated overlay for the selected divided bounding area 204.1 through 204.4.

For example, the first evaluator selects divided bounding area 204.2 to evaluate building 218.1 encompassed by divided bounding area 204.2 via the first user interface. The first evaluator opens the three-dimensional markup language file for divided bounding area 204.2. The first evaluator selects indicator 206.1 paired with building 218.1. The web page for indicator 206.1 is pulled from the structure evaluation server based on the geographic coordinates of building 218.1. The first evaluator changes the evaluation status via the web page. The structure evaluation server receives the updated web page. The structure evaluation server updates the evaluation status for building 218.1 by appropriately changing the color of indicator 206.1 and stores the evaluation status change based on the geographical coordinates for building 218.1. The structure evaluation server updates the three-dimensional markup language file for divided bounding area 204.2 to appropriately represent the change in evaluation status and stores the evaluation status change based on the geographical coordinates of divided bounding area 204.2. The structure evaluation sever also updates the evaluation status for divided bounding area 204.2 by appropriately changing the color of the overlay for divided bounding area 204.2. In doing so, when the second evaluator selects divided bounding area 204.2 via the second user interface, the color of indicator 206.1 may be provided with the updated color, the three-dimensional markup language file for divided bounding area 204.2 may be updated, and the overlay for divided bounding area 204.2 may be provided with the updated color.

In an embodiment, the evaluations completed by each evaluator may be provided to the structure evaluation server and stored. The evaluations may be referenced to select each building 218.1 through 228.2 that passed the evaluations to be rolled out for publication. The evaluations may also be referenced to determine which building 218.1 through 228.2 failed the evaluations so that building 218.1 through 228.2 may be deleted from publication and/or reprocessed to fix the distortions.

### System

FIG. 3. is a diagram showing a system 300 for evaluating buildings in a three-dimensional fashion using a three-dimensional model of the buildings and providing an evaluation status for the buildings. System 300 may operate as described above with respect to FIGS. 1-2. System 300 includes a client 302 coupled to a structure evaluation server 324 via one or more networks 322, such as the Internet. Client 302 includes a browser 304. Browser 304 includes a mapping service module 306, a dividing module 308, a selection module 310, a retrieving module 312, an evaluation module 314, a providing module 316, an evaluation web page 318 and an updated evaluation web page 320. Each of these components is described below.

In embodiments, browser 304 may be a FIREFOX, SAFARI, or INTERNET EXPLORER browser. The components of browser 304 may be downloaded from a server, such as a web server, and run with browser 304. For example, the components of browser 304 may be Hypertext Markup Language (HTML), JavaScript, or a plug-in, perhaps running native code. As mentioned above, mapping service module 306 is one such component. Mapping service module 306 displays a visual representation of a map, for example, as a viewport into a grid of map tiles. Mapping service module 306 is implemented using a combination of markup and scripting elements, for example, using HTML and JavaScript. Browser 304 displays a three-dimensional model provided by mapping service module 306 that may depict a three-dimensional representation of buildings geographically located within the grid of map tiles. A user interface may run in a standalone GIS application based on the three-dimensional model markup language.

Upon receipt of the three-dimensional model provided by mapping service module 306, browser 304 may display a large quantity of buildings as depicted by the three-dimensional model. The large quantity of buildings displayed by browser 304 may be too daunting of a task for evaluators to evaluate in an efficient manner. Dividing module 308 may divide the three-dimensional model displayed by browser 304 into divided bounding areas as illustrated in examples in FIG. 2. As illustrated in that figure, each divided bounding area encompasses a portion of the buildings displayed by browser 304. In doing so, each evaluator may evaluate each building encompassed by a particular divided bounding area before moving onto evaluating buildings encompassed by another divided bounding area.

Each divided bounding area provides an evaluation status of the divided bounding area to communicate to the evaluators the evaluation status of the buildings encompassed by the divided bounding area. Retrieving module 312 retrieves evaluation web page 318 for each divided bounding area from structure evaluation server 324 as illustrated in examples in FIG. 2. As illustrated in that figure, each evaluation web page 318 provides the evaluation status for each divided bounding area to the evaluators. In doing so, each evaluator may have an understanding as how to approach the evaluation of the buildings encompassed by the divided bounding area.

Structure evaluation server 324 may include a web server. A web server is a software component that responds to a hypertext transfer protocol (HTTP) request with an HTTP reply. The web server may serve content such as hypertext markup language (HTML), extendable markup language (XML), documents, videos, images, multimedia features, or any combination thereof. This example is strictly illustrative and does not limit the present invention.

Selection module 310 may select a divided bounding area. Once the divided bounding area is selected, the evaluator may commence the evaluation of the buildings encompassed by the selected divided bounding area.

Evaluation module 314 evaluates the buildings encompassed by the selected divided bounding area. Evaluation module 314 evaluates the buildings based on a visual representation of the buildings depicted by the three-dimensional model as displayed by browser 304.

In an embodiment, evaluation module 314 evaluates the buildings encompassed by the selected divided bounding area to determine whether each building may be distorted. The evaluation status of each building encompassed by the selected divided bounding area following the evaluation performed by evaluation module 314 may include “distorted,” “not distorted,” or “not yet evaluated.”

In a further embodiment, the selected divided bounding area itself may also have an evaluation status following the evaluation performed by evaluation module 314. The selected divided bounding area may have an evaluation status that communicates whether all of the buildings encompassed by the selected divided bounding area have been evaluated by evaluation module 314. The selected divided bounding area may have an evaluation status that communicates whether a portion of the buildings encompassed by the selected divided bounding area have been evaluated by evaluation module 314 but a portion of the buildings have not been evaluated. The selected divided bounding area may have an evaluation status that communicates that no buildings encompassed by the selected divided bounding area have been evaluated by evaluation module 314. For example, the evaluation status for the selected divided bounding area may include “not yet evaluated,” “partially evaluated,” or “evaluated.”

Once evaluation module 314 evaluates the buildings encompassed by the selected divided bounding area, providing module 316 may provide an updated evaluation web page 320 for the selected divided bounding area to structure evaluation server 324. Updated evaluation web page 320 may provide the updated evaluation status for each divided bounding area. The updated evaluation status may be determined from the evaluation of the selected divided bounding area by evaluation module 314. Providing module 316 may operate as described with respect to FIG. 2.

Each of client 302 and GIS server 324 may be implemented on any computing device. Such computing device can include, but is not limited to, a personal computer, mobile device such as a mobile phone, workstation, embedded system, game console, television, set-top box, or any other computing device. Further, a computing device can include, but is not limited to, a device having a processor and memory for executing and storing instructions. Software may include one or more applications and an operating system. Hardware can include, but is not limited to, a processor, memory and graphical user interface display. The computing device may also have multiple processors and multiple shared or separate memory components. For example, the computing device may be a clustered computing environment or server farm.

Each of browser 304, mapping service module 306, dividing module 308, selection module 310, retrieving module 312, evaluation module 314, and providing module 316 may be implemented in hardware, software, firmware, or any combination thereof.

Each of evaluation web page 318 and updated evaluation web page 320 may be stored in any type of structured memory, including a persistent memory. In examples, each database may be implemented as a relational database.

### Method

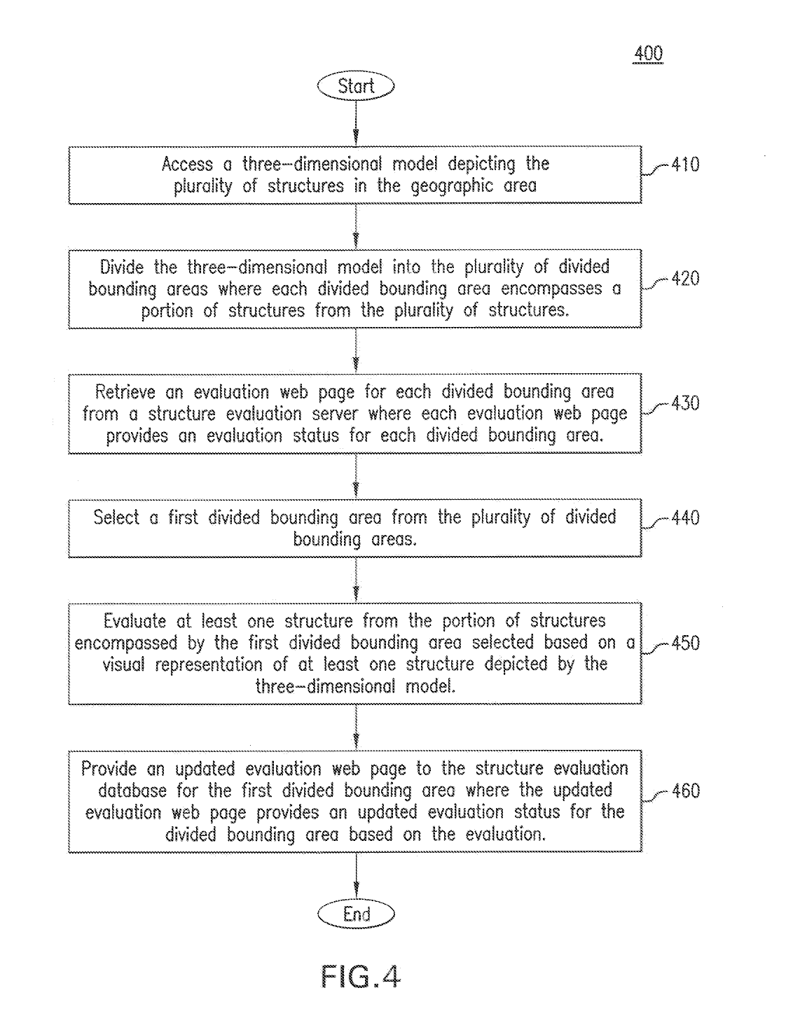

FIG. 4 is a flowchart showing a method 400 for evaluating geographical data that represents a plurality of structures located in a geographic area that is divided into a plurality of divided bounding areas using a three-dimensional model representing the plurality of structures.

Method 400 begins at step 410 with accessing a three-dimensional model depicting the plurality of structures in the geographic area. For example, as shown in FIG. 2, three-dimensional model 202 may be accessed and displayed via user interface 300 where three-dimensional model 202 depicts buildings 218.1 through 228.2.

At step 420, the three-dimensional model is divided into the plurality of divided bounding areas where each divided bounding area encompasses a portion of structures from the plurality of structures. For example, as shown in FIG. 2, three-dimensional model 202 may be divided into divided bounding areas 204.1 through 204.4. Each divided bounding area 204.1 through 204.4 includes a portion of buildings 218.1 through 228.2. For example, divided bounding area 204.2 includes buildings 220.1 and 220.2.

At step 430, an evaluation web page is retrieved for each divided bounding area from a structure evaluation server where each evaluation web page provides an evaluation status for each divided bounding area. For example, as shown in FIGS. 2 and 3, evaluation web page 318 for each divided bounding area 204.1 may be retrieved from structure evaluation server 324 where evaluation web page 318 may provide an evaluation status for divided bounding area 204.1.

At step 440, a first divided bounding area from the plurality of divided bounding areas is selected. For example, as shown in FIG. 2, divided bounding area 204.3 may be selected from divided bounding areas 204.1 through 204.4.

At step 450, at least one structure from the portion of structures encompassed by the first divided bounding area selected is evaluated based on a visual representation of the at least one structure depicted by the three-dimensional model. For example, as shown in FIG. 2, building 226.1 from buildings 226.1 through 226.2 encompassed by divided bounding area 204.4 is evaluated based on a visual representation of building 226.1 as depicted by three-dimensional model 202.

At step 460, an updated evaluation web page is provided to the structure evaluation database for the first divided bounding area where the updated evaluation web page provides an updated evaluation status for the first divided bounding area based on the evaluation. For example, as shown in FIGS. 2 and 3, updated evaluation web page 320 is provided to structure evaluation database 324 for divided bounding area 204.3 where updated evaluation web page 320 provides an updated evaluation status for divided bounding area 204.3 based on the evaluation.

### Additional Examples

In different examples, the geographic information system may be two-dimensional or three-dimensional. For example, different structures may be displayed as two and half dimensional images in map tiles. Alternatively, the structures may be displayed within a three-dimensional environment. The three-dimensional environment may be presented to a user from a perspective of a virtual camera, which can be navigated to different positions and orientations according to user inputs. Three-dimensional environment may also have geographic data tiles, perhaps in a quad node tree. Each tile may represent a rectangle bounded by certain latitude and longitude values and include data geocoded within the latitude and longitude values. The tile may also be restricted to a particular type of data. In this way, tiles having various types may be layered. In one example, within particular latitude and longitude bounds, different layers may include building structures, geographic terrain, and aerial imagery respectively. Moreover, each tile may have a level of detail. For example, a single tile specifying data is within particular latitude/longitude bounds may be associated with four additional tiles also specifying data within those latitude/longitude bounds. In this way, the tiles may construct a quad node tree.

Similar to how each tile can be bounded latitude by longitude values, the bounding boxes described above may also be bounded by latitude and longitude values. The tiles and bounding boxes may or may not be coextensive. The north/south/east/west latitude/longitude coordinates of each bounding box may be converted to a string that acts as a database key. For example, that string may become part of each structure's metadata and used for database lookups.

Each structure may be represented, for example, using extensible markup language (XML.) In one example, the structure may be represented using keyhole markup language (KML.)

In a further example, evaluators may be users and may evaluate the accuracy of three-dimensional models over the Internet. The users may be offered an incentive to perform the evaluation. Also, each user may have a reliability rating according to the skill, experience or quality of prior evaluations. For example, the rating may be determined by an administrator. Similarly, there may be a mechanism to report vandalism by users making false evaluations. The evaluation may be integrated, for example, in social media or social media websites. In this way, evaluation of three-dimensional models may be crowdsourced.

### CONCLUSION

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer-implemented method for evaluating geographical data that represents a plurality of structures located in a geographic area that is divided into a plurality of divided bounding areas using a three-dimensional environment representing the plurality of structures, comprising:
(a) accessing a three-dimensional environment depicting the plurality of structures in the geographic area;
(b) dividing the three-dimensional environment into the plurality of divided bounding areas, wherein each divided bounding area encompasses a portion of structures from the plurality of structures;
(c) providing an evaluation user interface for the plurality of divided bounding areas from a structure evaluation server, wherein the evaluation user interface provides an evaluation status for each divided bounding area;
(d) receiving a user selection, from the provided evaluation user interface, of a divided bounding area from the plurality of divided bounding areas;
(e) receiving a user evaluation of at least one structure from the portion of structures encompassed by the divided bounding area selected in step (d) based on a visual representation of the at least one structure depicted within the three-dimensional environment; and
(f) providing an updated evaluation user interface for the divided bounding area selected in step (d) to the structure evaluation server, the updated evaluation web page providing an updated evaluation status for the divided bounding area based on the evaluating in step (e).

2. The method of claim 1, wherein each divided bounding area controls a quantity of structures from the plurality of structures that is to be evaluated in step (e).

3. The method of claim 1, wherein the receiving (e) comprises receiving a user evaluation of each structure included in the divided bounding area based on an individual judgment of a user for each structure.

4. The method of claim 1, wherein the receiving (e) comprises receiving a user input indicating an evaluation of every structure included in the divided bounding area based on a single judgment of a user.

5. The method of claim 1, wherein the evaluation user interface includes an evaluation web page for each divided bounding area, each evaluation web page including a three-dimensional environment markup language file describing the divided bounding area that is represented by the evaluation web page.

6. The method of claim 5, wherein the three-dimensional environment markup language file provides the evaluation status for each divided bounding area based on a visual appearance of the three-dimensional environment markup language.

7. The method of claim 1, wherein the visual representation of the at least one structure is three-dimensional.

8. The method of claim 1, further comprising:
(g) assigning a set of geographical coordinates to each divided bounding area, wherein the set of geographical coordinates represents a geographical location of each structure encompassed by each divided bounding area.

9. A system for evaluating geographical data that represents a plurality of structures located in a geographic area that is divided into a plurality of divided bounding areas using a three-dimensional environment representing the plurality of structures, comprising:
a mapping service module that accesses a three-dimensional environment depicting the plurality of structures in the geographic area;
a dividing module that divides the three-dimensional environment into the plurality of divided bounding areas, wherein each divided bounding area encompasses a portion of structures from the plurality of structures;
a retrieving module that provides an evaluation user interface for each divided bounding areas from a structure evaluation server, wherein the evaluation user interface provides an evaluation status for each divided bounding area;
a selection module that receives a user selection, from the provided evaluation user interface, of a divided bounding area from the plurality of divided bounding areas;
an evaluation module that receives a use evaluation of at least one structure from the portion of structures encompassed by the divided bounding area selected by the selection module based on a visual representation of the at least one structure depicted by the three-dimensional environment; and
a providing module that provides an updated evaluation user interface for the divided bounding area selected by the selection module to the structure evaluation server, the updated evaluation web page providing an updated evaluation status for the divided bounding area based on the evaluating by the evaluation module.

10. The system of claim 9, wherein each divided bounding area controls a quantity of structures from the plurality of structures that is to be evaluated by the evaluation module.

11. The system of claim 9, wherein the evaluation module receives a user evaluation of i each structure included in the divided bounding area based on an individual judgment of a user for each structure.

12. The system of claim 9, wherein the evaluation module receives a user input indicating an evaluation of every structure included in the divided bounding area based on a single judgment, wherein the single judgment includes an evaluation for every structure included in the divided bounding area.

13. The system of claim 9, wherein the evaluation user interfaces includes an evaluation web page for each divided bounding area, each evaluation web page including a three-dimensional environment markup language file describing the divided bounding area that is represented by the evaluation web page.

14. The system of claim 13, wherein the three-dimensional environment markup language provides the evaluation status for each divided bounding area based on a visual appearance of the three-dimensional environment markup language.

15. The system of claim 9, wherein the visual representation of the at least one structure is three dimensional.

16. The system of claim 9, further comprising:
an assignment module that assigns a set of geographical coordinates to each divided bounding area, wherein the set of geographical coordinates represents a geographical location of each structure encompassed by each divided bounding area.

17. A computer storage medium encoded with a computer program, the program comprising instructions that when executed by one or more processors cause the one or more processors to perform operations, comprising:
(a) accessing a three-dimensional environment depicting the plurality of structures in the geographic area;
(b) dividing the three-dimensional environment into the plurality of divided bounding areas, wherein each divided bounding area encompasses a portion of structures from the plurality of structures;
(c) providing an evaluation user interface for the plurality of divided bounding areas from a structure evaluation server, wherein the evaluation user interface provides an evaluation status for each divided bounding area;
(d) receiving a user selection, from the provided evaluation user interface, of a divided bounding area from the plurality of divided bounding areas;
(e) receiving a user evaluation of at least one structure from the portion of structures encompassed by the divided bounding area selected in step (d) based on a visual representation of the at least one structure depicted within the three-dimensional environment; and
(f) providing an updated evaluation user interface for the divided bounding area selected in step (d) to the structure evaluation server, the updated evaluation web page providing an updated evaluation status for the selected divided bounding area based on the evaluating in step (e).

18. The computer storage medium of claim 17, wherein each divided bounding area controls a quantity of structures from the plurality of structures that is to be evaluated.

19. The computer storage medium of claim 17, wherein the receiving (e) comprises receiving a user evaluation of each structure included in the divided bounding area based on an individual judgment of a user for each structure.

20. The computer storage medium of claim 17, wherein the receiving (e) comprises receiving a user input indicating an evaluation of every structure included in the divided bounding area based on a single judgment of a user.

21. The computer storage medium of claim 17, wherein the evaluation user interface includes an evaluation web page for each divided bounding area, each evaluation web page including a three-dimensional environment markup language file describing the divided bounding area that is represented by the evaluation web page.

22. The computer storage medium of claim 17, wherein the visual representation of the at least one structure is three-dimensional.

23. The computer storage medium of claim 17, the operations further comprising:
(g) assigning a set of geographical coordinates to each divided bounding area, wherein the set of geographical coordinates represents a geographical location of each structure encompassed by each divided bounding area.
